(19) United States
(12) Patent Application Publication
(10) Pub. No.: US 2012/0073427 A1
(43) Pub. Date: Mar. 29, 2012

(54) IMPACT-RESISTANT AND PENETRATION-RESISTANT TEXTILE STRUCTURE, METHOD FOR PRODUCING SUCH TEXTILE STRUCTURE AND APPARATUS THEREOF

(75) Inventor: Giorgio Celeste CITTERIO, Monza (IT)

(73) Assignee: FRATELLI CITTERIO S.P.A., Monza (IT)

(21) Appl. No.: 13/078,512

(22) Filed: Apr. 1, 2011

(30) Foreign Application Priority Data
Sep. 23, 2010 (IT) MI2010A001733

(51) Int. Cl. F41H 5/04; B32B 7/08; B32B 38/08; B32B 3/06

(52) U.S. Cl. 89/36.02; 428/102; 156/93; 89/903; 89/904; 89/914

(57) ABSTRACT

The present invention refers to an impact-resistant and penetration-resistant textile structure, to a method and to an apparatus for production thereof.

### CROSS REFERENCE TO RELATED APPLICATIONS

This application claims the benefit of priority from Italian patent Application No. MI2010A 001733 filed Sep. 23, 2010, the contents of which are incorporated herein by reference.

### FIELD OF THE INVENTION

The present invention refers to an impact-resistant and penetration-resistant textile structure, to the method for producing such textile structure and to the apparatus for the actuation of such method.

### BACKGROUND OF THE INVENTION

The impact-resistant and penetration-resistant textile structure subject of the present invention can be used as a reinforcing structural material, as a semi-processed product for providing structural composite materials and ballistic articles, flexible or rigid.

The use of textile structures has been known over the years in the field of reinforcement materials, composite materials and in that of the ballistic articles.

The textile structures originally used in such sectors initially consisted of warp and weft textiles.

The so-called “semi-unidirectional” or “unidirectional” textile structures have been introduced over the years as an alternative to warp and weft textiles. Such textile structures consist of two or more superimposed planes of the threads, wherein the threads of each plane are arranged parallel to each other and with rectilinear development—hence the definition of “unidirectionality”—while the threads of two adjacent planes are oriented differently one with respect to the other.

The characteristics of resistance to the impact of such “unidirectional” textile structures were then improved through the application of resins (polymers) thereto; this in particular with the aim of avoiding, upon impact (knock or penetration), the threads free to move from being opened allowing an easy penetration of the projectile.

Textile structures with “semi-unidirectional” or “unidirectional” threads are known for example from U.S. Pat. No. 7,148,162 B2 and EP 0 683 374 B1, both on behalf of Andrew D. Park, U.S. Pat. No. 5,354,605 on behalf of Allied Signal Inc., WO 02/090866 on behalf of Barrady Inc., WO 2005/028724 on behalf of Honeywell Inc., US 2004/0045428 (WO01/78975) and EP 0 805 332 A2 both on behalf of Citterio, U.S. Pat. No. 7,073,538 on behalf of Bhatnagar Ashok and others.

The present invention proposes to improve such state of the art.

In particular, the known textile structures of “unidirectional” type are characterised by a very compact and dense structure which required adopting particular solutions aimed at facilitating the penetration of the resins therein.

Typically, the penetration of the resin in such known structures was facilitated by reducing the viscosity of the resins and/or by selecting resins based on polymers with low molecular weight and/or by applying high pressures to the textile structures with the aim of facilitating the distribution of the resin applied thereto or providing fabrics too light to be useful for ballistic purposes.

However, it was observed that the reduction of viscosity implies the deterioration of the capacity of cohesing the fibres of the threads; the use of polymers with low molecular weight thus deteriorates the characteristics of the textile structures to resist to the impact, making them unsuitable for providing ballistic articles, and the application of high pressures generally required to obtain good ballistic performances was proven to be unsuitable to guarantee a uniform distribution of the resin which tends to flow out from the sides of the textile structure.

Thus, an object of the present invention is to propose a method for the production of an impact-resistant and penetration-resistant textile structure of the unidirectional type capable of allowing uniformly distributing resins therein even at high viscosity or with a limited use of diluents.

Another object of the present invention is to propose an impact-resistant and penetration-resistant textile structure, of the unidirectional type, capable of allowing the resin applied thereto to be distributed in a uniform and homogeneous manner.

Furthermore, the “unidirectional” textile structures of known type are currently made with looms or machines referred to as “multi axial machines” or with looms or machines referred to as “biaxial machines”, both produced, for example, by Liba Machinenbau GmbH.

“Multi axial machines” allow depositing, in succession one after the other and one on the other, different flat layers of unidirectional threads to form a continuous tape. Each flat layer consists of a bundle of the threads parallel to each other and the threads of one layer are oriented according to an angle comprised between 0° and 90° with respect to the threads of the layer underlying with respect thereto. During the formation of the tape, a film made of polymeric material can be inserted between two layers of the superimposed threads. The layers of the threads thus superimposed, with the possible interposition of films made of polymeric material, are then joined by knit stitching. Such knit stitching is carried out by needles which traverse the thickness of the various superimposed layers binding them with a binding thread. The tape thus obtained is wound in a roll.

Such “multi axial machine” however reveals several drawbacks.

A first drawback lies in the fact that should the threads of two successive layers be deposited with a relative orientation of 0°/90°, the successive knit stitching of the same does not allow obtaining a symmetric structure, instead required to provide high characteristics of resistance to impact. The threads at 0° with respect to the weaving direction are actually stitched in bundles, while the threads at 90° with respect to the weaving direction are stitched individually.

In order to obtain a symmetric textile structure, one is forced and limited to deposit the threads of two successive layers with a relative orientation of +45°.

Another drawback lies in the fact that when performing knit stitching the needles randomly penetrate through the threads of the various superimposed layers with respect to each other. For this reason, the needles, while penetrating, at least partly damage the threads themselves.

Yet another drawback lies in the fact that the threads of each layer which are deposited by a respective thread guide head can be subjected to movements and waving on the plane during their deposition, thus diverting from the required unidirectionality, if not even superimposing on each other, jeopardizing the regularity of the structure and the resistance properties thereof.

Known “textile machines” of the so-called “biaxial” type instead allow depositing on each other two layers of the unidirectional threads, in which the threads of one layer are oriented at 90°+/−5° with respect to the threads of the other layer and in which the two layers are knit stitched to each other using needle devices that do not traverse the threads, preserving wholeness thereof.

However, even these biaxial textile machines reveal some drawbacks which limit use thereof in the field of textile structures resistant to impact.

A first drawback lies in the fact that the known biaxial textile machines, provide for the application, before stitching, of a reinforcement or coating layer only on one of the two opposite sides of the structure consisting of two layers of the unidirectional threads superimposed with respect to each other, while they do not provide for the insertion of an intermediate layer between such two layers of threads very useful in relation to the ballistic performance.

Another drawback of such biaxial textile machines lies in the fact that, due to the mechanical structure thereof they do not allow inserting, in the warp direction, a number of threads exceeding a maximum limit equivalent to eighteen threads per inch (18 threads/inch) maintaining the symmetry of the structure derived therefrom.

For example, if with a number of warp threads lower or equivalent to such maximum limit, such biaxial textile machines allow obtaining bidirectional structures wherein each weft thread corresponds to a warp thread, which are joined by a binding point, with a number of the warp threads exceeding such maximum limit, instead, it is not possible to obtain bidirectional structures having such “symmetric” structure, required for ballistic purposes.

Regarding this, on one hand it should be observed that, inserting a number of the warp threads lower or equivalent to eighteen threads per inch and using threads with counts comprised between 200 dtex and 2000 dtex, these counts being particularly useful for ballistic use, would allow obtaining textiles whose weight is lower than that required for ballistic tissues. Thus, operating within the set limits, bidirectional structures of symmetric construction, i.e. in which a warp thread corresponds to a weft thread and a binding point is however obtained, but not applicable with the ballistic sector due to unsuitable weight.

On the other hand, it would be possible—in known biaxial textile machines—to obtain textiles with higher weight by increasing the number of weft threads with respect to the warp threads, but this would give rise to a bidirectional structure of asymmetric construction, also unsuitable for the ballistic sector.

Thus, another object of the present invention is to propose an impact-resistant and penetration-resistant textile structure of the symmetric structure unidirectional type, regardless of the density of the threads arranged at 0° or arranged at 90°, i.e. regardless of the frequency of the number of the threads deposited in the direction at 0° and in the direction at 90°, and whose threads are whole and not damaged by the penetration of the needles.

A further object of the present invention consists in proposing an apparatus comprising an improved textile machine of the biaxial type capable of continuously producing an impact-resistant and penetration-resistant textile structure and of the unidirectional type as specified above and capable of allowing inserting also an intermediate layer between the two planes or layers of the unidirectional threads.

### SUMMARY OF THE INVENTION

These objects according to the present invention are attained by means of an impact-resistant and penetration-resistant textile structure which includes:
a first bundle of unidirectional threads which are arranged parallel to each other on the same first plane;
a second bundle of unidirectional threads which are arranged parallel to each other on the same second plane;
   wherein said first plane and said second plane are superimposed, with the threads of the first bundle oriented at 90°+/−5° with respect to the threads of the second plane and wherein
at least one intermediate layer is interposed between the first plane and the second plane, whereby or characterized in that:
   the threads of the first bundle, also differing in nature and/or count, are joined with a biunivocal correspondence relation to the threads of the second bundle, also differing in nature and/or count, by knit stitching passing through the intermediate layer and in that
   the coverage factor referring to the threads of the first and second bundle is less than 100%, with a uniform and symmetrical distribution of the discontinuity coverage areas on the first plane and on the second plane, wherein the volume of the discontinuity coverage areas is reduced by at least 5% after pressing and wherein the discontinuity coverage areas act as collection and distribution cavities of at least one polymeric substance present in or applied to the threads, and/or to the intermediate layer and/or to the structure, following the pressing.

Further characteristics of the textile structure according to the present invention are specified in the dependent claims.

These objects are also attained through a method for the production of an impact-resistant and penetration-resistant textile structure and through an apparatus as described hereinbelow. Further characteristics of the apparatus according to the present invention are defined in the dependent claims.

### BRIEF DESCRIPTION OF THE DRAWINGS

The characteristics of the present invention shall be clearer from the following exemplifying and non-limiting description with reference to the attached schematic drawings wherein:

FIG. 1 schematically shows an apparatus comprising a biaxial textile machine according to the present invention;

FIG. 2 schematically shows and on enlarged scale a detail of the textile machine of the apparatus of FIG. 1;

FIG. 3 schematically shows, in projection on the plane and on enlarged scale a textile structure according to the present invention;

FIGS. 4a and 4b schematically show, in projection on the plane and on enlarged scale two further textile structures according to the present invention;

FIG. 5a schematically shows, in cross-section and on enlarged scale a unidirectional textile structure according to the prior art impregnated with resin, respectively before and after the application of a pressure;

FIG. 5b schematically shows, in cross-section and on enlarged scale a unidirectional textile structure according to the present invention impregnated with resin, respectively before and after the application of a pressure.

### DETAILED DESCRIPTION OF THE INVENTION

With particular reference to the attached figures, an impact-resistant and penetration-resistant textile structure of the unidirectional type subject of the present invention is indicated in its entirety with 100. The textile structure 100 comprises at least:
a first bundle of unidirectional threads 101 which are arranged parallel to each other on the same first plane,
a second bundle of unidirectional threads 102 which are arranged parallel to each other on the same second plane, in which such first plane and such second plane are overlapped each other, with the threads 101 of the first bundle oriented at 90°+/−5° with respect to the threads 102 of the second plane, and
an intermediate layer 106 interposed between the first plane of the threads 101 and the second plane of the threads 102.

A first distinctive characteristic of the textile structure 100 according to the present invention consists in the fact that the threads 101 of the first bundle are joined with knit stitching with binding threads 103 to the threads 102 of the second bundle with a biunivocal correspondence ratio. The expression biunivocal correspondence ratio is used to indicate the fact that an n number of threads 101 of the first bundle, also differing in nature or count, is joined with knit stitching to an equivalent n number of threads 102 of the second bundle, also differing in nature or count.

The fact that the threads 101, 102 of each group of n threads, i.e. the threads 101, 102 present in the same pitch, can be different from each other by nature or count allows modifying the weight of the textile structure 100 in a simple and inexpensive manner, without requiring modifying the frequency of the stitching needles.

The term knit stitching is used to indicate a tricot stitching, a open or closed loop stitch or the like.

According to a further characteristic aspect of the present invention, the textile structure 100 has a coverage factor referring to the threads 101 of the first bundle and to the threads 102 of the second bundle lower than 100%, with a uniform and symmetrical distribution of the discontinuity coverage areas 104 on the first plane of the threads 101 and on the second plane of the threads 102. The volume of the discontinuity coverage areas 104 is reduced by at least 5% after a pressing operation and the same discontinuity coverage areas 104 act as cavities for collecting and distributing at least one polymeric substance or resin present in or applied to the threads 101 and/or 102, to the intermediate layer 106 or to the entire structure 100, after pressing the same.

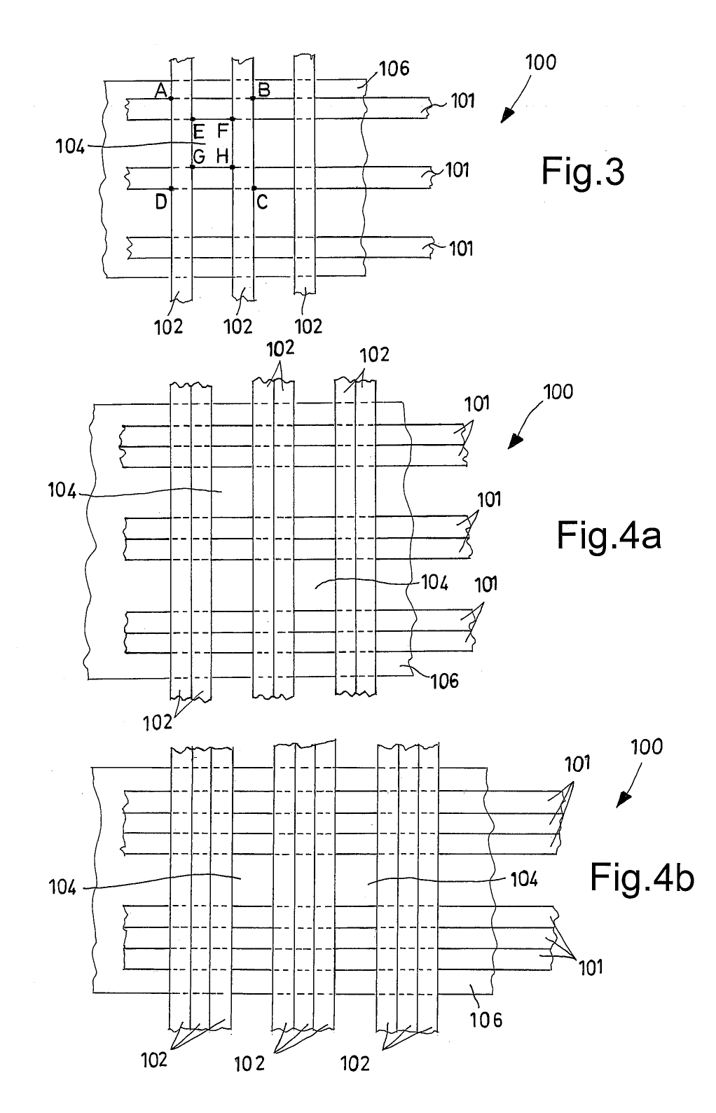

With particular reference to the diagram indicated in FIG. 3, regarding the present description the term “coverage factor” is used to indicate the ratio between the delimited total area A-B-C-D, considering the plane projection of a textile structure 100, between two threads 101 or two consecutive groups of n-threads 101 of the first bundle and two threads 102 or two consecutive groups of n-threads 102 of the second bundle and the area E-F-G-H of the coverage discontinuity area 104 within the area A-B-C-D and not covered by the threads 101 and 102.

Regarding this, it is observed that in the field of structural composite materials and for ballistic articles, textile structures with a coverage factor equivalent to or tending towards 100% are commonly and widely used for achievement thereof.

Thus, in such sector there is the tendency to provide textile structures as compact and dense with the thread as possible. Actually, it is commonly known that the greater the density of the threads, the higher the resistance to the impact offered by the textile structure.

In sharp contrast with such trend, the applicant surprisingly discovered that the use of textile structures with a coverage factor lower than 100%, preferably lower than 98%, and, thus, characterized by the presence of discontinuity coverage areas 104, allow obtaining composite materials with high resistance to impact.

Actually, the coverage discontinuity areas 104, act as cavities for collecting and distributing the polymeric substance or resins that are directly of indirectly applied to the textile structure. The subsequent application of pressure and temperature on the surfaces of the textile structure forces the resin to penetrate through the fibres of the threads wetting them more or less intimately depending on the pressure. Furthermore, the collection cavities block the migration of the resin towards the sides of the textile structure subjected to pressure. In the known compact textile structures to which the resins are applied, on the contrary, the application of the pressure required to improve the ballistic qualities creates considerable outflow of the resins from the sides of the textile structure and, thus, with an unacceptable concentration gradient of resin width-wise.

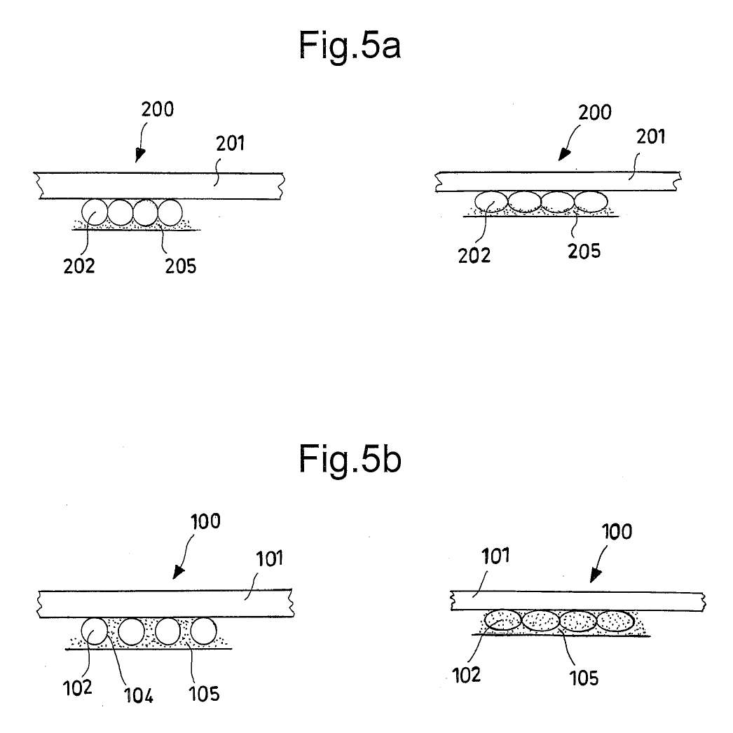

A section of a portion of a textile structure 200 according to the prior art, in which the unidirectional threads 201 and 202 of the two planes superimposed with respect to each other have a coverage factor of 100% and to which the resin 205 was applied, respectively before and after the application of a pressure is indicated schematically and in enlarged scale in FIG. 5a. After application of the pressure, the resin 205 tends to accumulate on the sides and towards the outer surface of the textile structure 200 and to penetrate into the threads 202 only partly. Thus, the surplus is forced to flow to the sides of the structures.

A section of a portion of a textile structure 100 according to the present invention (without, for the sake of representation simplicity, the binding threads 103 and the intermediate layer 106), in which the unidirectional threads 101 and 102 of the two planes superimposed with respect to each other have a coverage factor lower than 100% and to which the resin 105 was applied, respectively before and after the application of pressure is instead indicated schematically and on enlarged scale in FIG. 5b.

Due to the presence of the discontinuity coverage areas 104, the resin 105 also tends to accumulate in such discontinuity coverage areas 104. Subsequent to application of the pressure, the resin is forced to penetrate through all the fibres of the threads and not only on the sides or outside with respect thereto, as in the case of the prior art. Thus, there is no surplus resin forced to flow to the sides of the structure.

In order to obtain symmetric textile structures, it is necessary that the discontinuity coverage areas 104 have a uniform and symmetric distribution at the first and the second plane of the threads 101 and 102.

The threads 101 of the first bundle and/or the threads 102 of the second bundle comprise threads having the following characteristics:

| | |
|---|---|
| tenacity | >6 g/dtex |
| module | >150 g/dtex |
| count | 50 dtex ÷ 40000 dtex |

By way of non-limiting example, the threads 101 of the first bundle and/or the threads 102 of the second bundle are of organic nature and constituted of fibres with high tenacity and resistance, selected from among the group comprising at least: polyaramide, copolyaramide, polyvinyl alcohol, polypropylene, polyethylene, polyacrylonitrile, polyesters, polybenzoxazole, polybenzotiazole and others.

Alternatively or in combination, still by way of non-limiting example, the threads 101 of the first bundle and/or the threads 102 of the second bundle are of inorganic nature and they are constituted by fibres with high tenacity and resistance, selected from the group comprising at least: glass, iron, basalt, ceramic, titanium, and others.

Furthermore, the threads 101 of the first bundle can be different from each other by nature and/or count, likewise the threads 102 of the second bundle can be different from each other by nature and/or count. In particular the threads 101 and 102 present in the same pitch of weaving can be different from each other by nature and/or count.

It should be specified that the term threads is used to indicate yarns with continuous threads even twisted, textured, traslanised. It is also specified that the term threads is also used to indicate elements in form of strip, plates and the like. The knit stitching is provided using binding threads both conventional, such as for example polyester, polyamide, polypropylene, cotton and the like and of the high tenacity type as for example referable to the ballistic threads used for base structure.

Furthermore, the binding threads 103 may comprise, even mixed together, threads of the type soluble in solvent, threads of the thermofusible type or threads of the infusible type. In particular binding threads soluble, in water or any other solvent, or of or of the thermofusible type are used, should one intend to obtain a final textile structure without such threads. Even more in particular, the same binding threads, if constituted by thermofusible polymers, can be part of the resin used to impregnate the threads. The count of such binding threads should be at least 10% lower than the count of the ballistic thread.

It is clear that the choice of the threads 101 and 102 of the two bundles and of the binding threads 103 and the presence percentage thereof depends on the final characteristics intended to be obtained and depends on various factors.

The polymeric substance applied indirectly or directly to the textile structure 100 is selected from among thermoplastic, thermosetting, elastomeric, dilating, viscous and/or viscoelastic polymers and mixtures thereof.

Regarding the coverage factor, it depends on various factors among which the count of the threads of the two bundles, the type of resin applied, the use of pre-impregnated threads, interposition of the film or adhesive layers etc between the two planes of the threads.

Lastly, regarding the intermediate layer 106, it can have a continuous or discontinuous structure. The term discontinuous structure is used to indicate a bundle of the threads, tapes, strips, mesh or the like. The term continuous structure is used to indicate a film, a tape, a fabric, a non-woven fabric, a textile structure and the like, in such case, it should be of the type penetrable by the stitching needles.

In the attached figures, the intermediate layer 106 is illustrated only schematically.

Purely by way of non-limiting example, the intermediate layer 106 is selected from the group comprising:
films, threads, tapes or strips made of polymeric, thermoplastic, thermosetting, elastomeric material or mixtures thereof;
adhesive substance also deposited by spraying;
felt or felt pre-impregnated with polymeric, thermoplastic, thermosetting or elastomeric material;
fabrics;
non-woven fabrics.

Preferably, the intermediate layer 106 has a weight comprised between 5 g/m² and 500 g/m².

On the contrary the overall weight of the textile structure is comprised between 100 g/m² and 3000 g/m².

Regarding the outer layer optionally laminated to at least one of the two sides of the textile structure 100, it can for example be constituted by a continuous or discontinuous film made of a polymeric material, by a polymeric-based non-woven fabric, by a tape or any other element also containing a load of solid particles dispersed therein.

The textile structure 100 according to the present invention can be used alone or superimposed with analogous structures to obtain composite materials, as a reinforcing structural material, for example for parts of vehicles, helmets or other products, or for providing rigid or flexible ballistic protection and the like.

In FIGS. 4a and 4b some possible bidirectional structures are represented according to the present invention in which the threads 101 of the first bundle are respectively bound with a biunivocal ratio 2:2 and 3:3 to the threads 102 of the second bundle through binding threads 103.

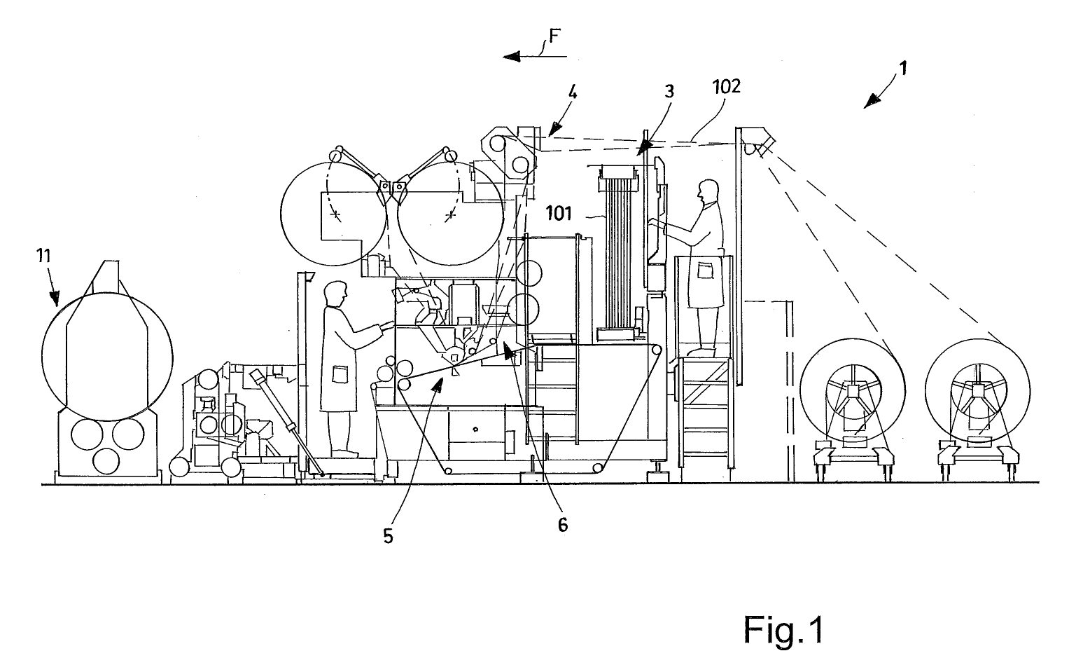

The textile structure 100 according to the present invention is obtained using apparatus 1 represented in FIG. 1.

The apparatus 1 comprises a biaxial textile machine which in turn comprises:
a supporting frame to which an advancement line is associated which defines an advancement direction F and on which there operates in succession a first head 3 and a device 4 for depositing the threads, in which the first head 3 deposits the first bundle of the threads 101 arranged on a first plane and parallel to each other at 90°+/−5° with respect to the advancement direction F and the device 4 deposits the second bundle of the threads 102 arranged on a second plane, superimposed with respect to the first, and parallel to each other at 0°+/−5° with respect to the advancement direction F,
a knit stitching device 5 arranged downstream, with respect to the direction of advancement F, of the first head 3 and of the device 4 and adapted to join the threads 101 of the first bundle to the threads 102 of the second bundle according to a biunivocal correspondence ratio,
a pulling and collection group 11 of the textile structure 100, which is arranged downstream, with respect to the direction of advancement F of the stitching device 5.

The apparatus 1 further comprises an insertion group 6 of at least one intermediate layer 106 between the first plane of the threads 101 and the second plane of the threads 102, which is interposed between the first head 3 and the device 4 and is adapted to distribute the intermediate layer 106 also at a different speed with respect to the distribution rate of the first bundle and of the second bundle of the threads 101 and 102 along the line 2.

The structure 1 is subjected to a first pressing which stabilises the fabric, by applying a pressure comprised between 3 and 250 bars and at a temperature comprised between 20° C. and 500° C.

The fabric thus stabilised is further impregnated even discontinuously with thermoplastic, thermosetting, elastomeric, viscous, viscoelastic polymers optionally diluted in solvent.

It is in this step that the polymers applied occupy the empty spaces—cavities—of the textile structures.

In a preferred embodiment, the binding threads are thermoplastic or even soluble in the solvent of the polymeric substance so that upon completing their task of temporarily keeping joined the layers of the threads before the pressing and intermediate layer may also not be further present.

The fabric thus impregnated is subjected to further pressing at a pressure comprised between 3 and 250 bars and at a temperature comprised between 20° C. and 500° C.

In this step, the cavities where the resin is deposited perform their task.

Actually, the reduction of the volume of the cavities after applying pressure and temperature forces the resin to penetrate the fibres of the yarns which delimit the cavities “wetting” them completely.

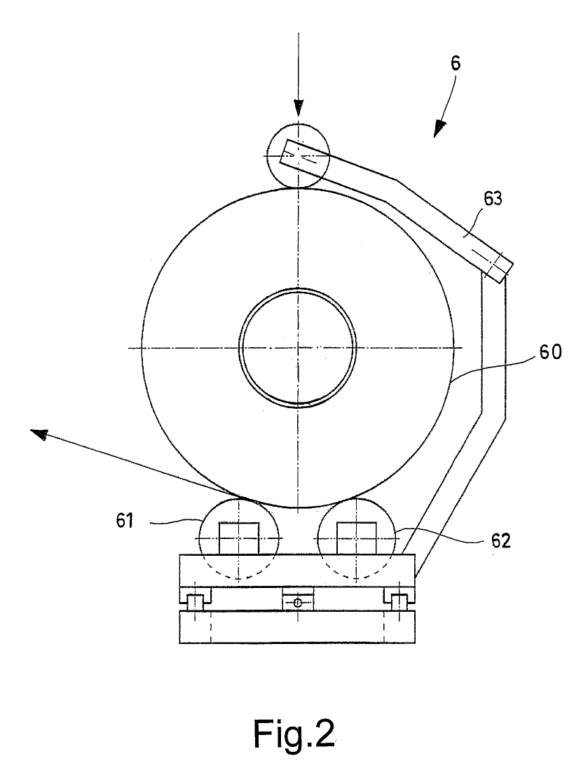

The apparatus 1 is characterized by the presence of the insertion group 6 of the intermediate layer 106 which, as schematically represented in FIG. 2, comprises at least one roll 60 around which the intermediate layer 106 is wound, whether continuous, discontinuous or consisting of a bundle of the threads, strips or tapes, which is supported rotatably and idle around the axis thereof and a braking device associated to the roll 60 so as to control the speed of advancement of the intermediate layer 106 along the advancement line 2.

In a preferred embodiment, the braking device comprises a pair of support rolls 61, 62 which are parallel to the roll 60 and on which the roll 60, in which at least one of such support rolls 61, 62 is activated by an electric motor of the stepper type associated to an inverter, rests.

Furthermore, an arm pressure 63 is provided adapted to keep the roll 60 resting on support rolls 61, 62 as the diameter of the roll 60 reduces following the unwinding of the intermediate layer 106.

Due to the possibility of controlling the advancement speed of the intermediate layer 106 it is possible to keep such layer suitably tensioned for the penetration of stitching needles thereinto without the latter pulling it with them in their binding movement.

The information provided above allows a man skilled in the art to understand the operation of the apparatus 1 and the method for the production of the textile structure 100 according to the present invention.

The textile structure according to the present invention has shown by way of experiment ballistic performance greater than that of the known structures.

The impact-resistant and penetration-resistant textile structure, the method for production thereof and the apparatus for the actuation of the method thus conceived are susceptible to various modifications and variants, all falling within the scope of the invention; furthermore, all details can be replaced by technically equivalent elements. In practice the materials used, as well as the dimensions, may vary according to the technical requirements.

1) An impact-resistant and penetration-resistant textile structure, comprising:
a first bundle of unidirectional threads which are arranged parallel to each other on the same first plane;
a second bundle of unidirectional threads which are arranged parallel to each other on the same second plane;
wherein said first plane and said second plane are superimposed, with the threads of said first bundle oriented at 90°+/−5° with respect to the threads of said second plane and wherein
at least one intermediate layer is interposed between said first plane and said second plane, wherein
the threads of said first bundle, also differing in nature and/or count, are joined with a biunivocal correspondence relation to the threads of said second bundle, also differing in nature and/or count, by knit stitching passing through said intermediate layer and wherein
the coverage factor referring to the threads of said first and second bundle is less than 100%, with a uniform and symmetrical distribution of the discontinuity coverage areas on said first plane and on said second plane, wherein the volume of said discontinuity coverage areas is reduced by at least 5% after pressing and wherein said discontinuity coverage areas act as collection and distribution cavities of at least one polymeric substance present in or applied to said threads, and/or to said intermediate layer and/or to said structure, following said pressing.

2) The structure according to claim 1, wherein said knit stitching is effected with binding threads having a count lower than at least 10% with respect to the count of the threads of said first bundle and said second bundle.

3) The structure according to claim 1, wherein the threads of said first bundle and/or the threads of said second bundle comprise threads having the following characteristics:

| | |
|---|---|
| tenacity | > 6 g/dtex |
| module | >150 g/dtex |
| count | 50 dtex ÷ 40000 dtex. |

4) The structure according to claim 1, wherein it comprises at least one outer layer applied to at least one of its outer sides.

5) A ballistic article, a reinforced structural article or a composite material comprising at least one layer consisting of a textile structure according to claim 1.

6) A semi-processed product for the production of ballistic articles, composite materials or as a reinforcing structural material comprising the textile structure of claim 1.

7) A method for the production of a textile structure according to claim 1, comprising:
depositing, with a biaxial machine, a first bundle of unidirectional threads, also differing in nature and/or count in a same pitch, arranged, on a same first plane, parallel to each other at 90°+/−5° or at 0°+/−5° with respect to the advance direction of said structure and a second bundle of unidirectional threads, also differing in nature and/or count in a same pitch, arranged, on a same second plane superimposed with respect to the first, parallel to each other at 0°+/−5° or at 90°+/−5° respectively, with respect to said advance direction;
inserting, during said depositing, at least one intermediate layer between said first plane and said second plane;
joining the threads of said first bundle with a biunivocal correspondence relation to the threads of said second bundle, with a knit stitching passing through said intermediate layer so that said structure has a coverage factor referring to the threads of said first and second bundle lower than 100%, with a uniform and symmetrical distribution of the discontinuity coverage areas on said first plane and on said second plane,
stabilizing said structure by the application of a pressure ranging from 3 to 250 bar and at a temperature ranging from 20° C. to 500° C.,
impregnating said structure with thermoplastic, thermosetting, elastomeric, viscous or viscoelastic polymers,
pressing said structure a second time at a pressure ranging from 3 to 250 bar and at a temperature ranging from 20 to 500° C. so that the volume of the discontinuity areas is reduced by at least 5%, where said discontinuity coverage areas act as collection and distribution cavities of said polymers.

8) The method according to claim 7, comprising, after said pressing, an application phase of at least one outer layer to at least one of the two sides of said structure.

9) An apparatus for effecting the method according to claim 7, comprising a biaxial textile machine comprising:
a supporting frame with which an advance line is associated, which defines an advance direction (F) and on which a first head and a thread depositing device operate in succession, wherein said first head deposits a first bundle of threads arranged on a first plane and parallel to each other at 90°+/−5° or at 0°+/−5° with respect to said advance direction, and said device deposits a second bundle of threads arranged on a second plane, superimposed with respect to the first, and parallel to each other at 0°+/−5° or at 90°+/−5° with respect to said advance direction,
a knit stitching device positioned downstream, with respect to the advance direction (F) along said line, of said first head and said device and suitable for joining the threads of said first bundle to the threads of said second bundle according to a biunivocal correspondence relation,
a pulling and collection group of the textile structure comprising said first plane of threads and said second plane of threads superimposed with respect to each other, which is situated downstream, with respect to the advance direction along said line, of said stitching device, wherein it comprises:
an insertion group of at least one intermediate layer between said first plane and said second plane, wherein said insertion group is interposed between said first head and said device and is suitable for distributing said intermediate layer also at a different rate with respect to the distribution rate of said first bundle and said second bundle along said line.

10) The apparatus according to claim 9, wherein said insertion group comprises at least one roll around which said intermediate layer is wound and which is rotatingly supported and idle around its own axis and a braking device associated with said roll.

11) The apparatus according to claim 10, wherein said braking device comprising at least one pair of resting rolls which are parallel to said roll and on which said roll rests, wherein at least one of said resting rolls is activated by an electric motor of the stepper type associated with an inverter.
